(19) United States
(12) Patent Application Publication
(10) Pub. No.: US 2025/0173485 A1
(43) Pub. Date: May 29, 2025

(54) Method for Intelligent Design and Application of Offshore Wind Turbine Structures Based on Sequential Knowledge Distillation and Transfer Learning

(71) Applicant: Sichuan University, Chengdu (CN)

(72) Inventors: Yuxiao LUO, Chengdu (CN); Kaoshan DAI, Chengdu (CN); Hang DU, Chengdu (CN); Jianze WANG, Chengdu (CN); Junlin HENG, Chengdu (CN); Qinlin CAI, Chengdu (CN); Yunlong GUO, Chengdu (CN)

(73) Assignee: Sichuan University, Chengdu (CN)

(21) Appl. No.: 18/957,923

(22) Filed: Nov. 25, 2024

(30) Foreign Application Priority Data
Nov. 28, 2023 (CN) 202311601944.X

(51) Int. Cl. G06F 30/27; G06F 30/13

(52) U.S. Cl. CPC G06F 30/27; G06F 30/13

(57) ABSTRACT

The provided is a method for intelligent design and application of offshore wind turbine structures based on sequential knowledge distillation and transfer learning. The method includes the following steps: S1, obtaining the open data set of the offshore wind turbine structures; S2, more than three random initialization lightweight network models are obtained, under the supervision of the intelligently designed artificial intelligence regression model of the offshore wind turbine structure as the teacher model, the knowledge distillation of the lightweight network model is performed to obtain the student model; S3, transfer learning is used for the student model, and the undeclared environmental parameters, wind turbine parameters and structural design parameters of the offshore wind power commercial wind turbine of the enterprise are accessed to obtain a lightweight model for the megawatt commercial wind turbine, and the regression model with the highest accuracy is screened.

### CROSS-REFERENCE TO THE RELATED APPLICATIONS

This application is based upon and claims priority to Chinese Patent Application No. 202311601944.X, filed on Nov. 28, 2023, the entire contents of which are incorporated herein by reference.

### TECHNICAL FIELD

The invention relates to the field of offshore wind turbine structure design technology, in particular to a method for intelligent design and application of offshore wind turbine structures based on sequential knowledge distillation and transfer learning.

### BACKGROUND

The environmental loads on offshore wind power towers are more complex, and the forms of wind power tower structures are different (such as fixed type, floating type, etc.). Moreover, the design of offshore wind turbine structures is affected by the individual and coupling effects of environmental parameters such as wind, wave, ocean current, tide, soil, etc., which makes one round of accurate load calculation and structural design take a long time, in addition, the design of wind power towers requires multiple rounds of iteration, which makes the design of offshore wind power towers a complex and challenging process.

Driven by the era of data science, it is possible to realize intelligent substitution of complex work through computer deep learning, however, to meet the needs of offshore wind power design and application scenarios, the depth of deep learning models is increasing, and the structure is becoming more and more complex, which brings a huge amount of calculation and makes model transmission extremely difficult. In addition, the wind power industry has its particularity, the fan parameters, such as control strategy, impeller airfoil parameters, generator set parameters, etc., belong to the confidential information of each wind power enterprise. Therefore, even if the intelligent design product of offshore wind turbine structure is developed, it is not easy to realize the large-scale application and promotion of the product in the industry.

### SUMMARY

The purpose of the invention is to provide a method for intelligent design and application of offshore wind turbine structures based on sequential knowledge distillation and transfer learning, which can effectively provide a scheme for the intelligent design of offshore wind turbine structures of enterprises, and complete the efficient design method for offshore wind turbine structure.

In order to achieve the above purpose, the invention provides a method for intelligent design and application of offshore wind turbine structures based on sequential knowledge distillation and transfer learning, including the following steps:

S1, obtaining an open data set of offshore wind power, and dividing the obtained data set into a training set and a test set, pre-training an intelligently designed artificial intelligence regression model of an offshore wind turbine structure, input parameters are wind turbine parameters and sea environment parameters, and output parameters are offshore wind turbine structure design parameters.

S2, obtaining more than three random initialization lightweight network models, under a supervision of the intelligently designed artificial intelligence regression model of the offshore wind turbine structure as a teacher model, performing a knowledge distillation of the lightweight network models to obtain a highly similar lightweight student model with a same input as the teacher model and an output difference within 5%;

S3, performing a transfer learning for the student model, and accessing undeclared environmental parameters, wind turbine parameters, and structural design parameters of an offshore wind power commercial wind turbine of an enterprise to obtain a lightweight model for a megawatt commercial wind turbine, and screening a regression model with a highest accuracy.

Preferably, the wind turbine parameters in S1 include wind wheel diameter, rated power, rated speed, design life, mechanical system type, and control system type.

Preferably, the sea environment parameters in S1 include wind speed range, average wind speed, turbulence type, turbulence model, turbulence intensity, wind profile distribution type, surface roughness, horizontal inflow angle, vertical inflow angle, wave simulation method, wave amplitude, wave theory type, swimming speed, water depth, wave period, wave height and wave direction.

Preferably, the offshore wind turbine structure design parameters in S1 include tower diameter, height, and thickness.

Preferably, an output height in S2 is determined by a loss function, a damage function between the teacher model and the student model of the regression model for knowledge distillation is L_{reg}, the calculation method is:

$${L}_{r e g} = {L}_{sL 1} ( {R}_{s} , {y}_{r e g} ) + v {L}_{b} ( {R}_{s} , {R}_{t} , {y}_{r e g} )$$

$${L}_{b} ( {R}_{s} , {R}_{t} , {y}_{reg} ) = \{ \begin{matrix}{‖ {R}_{s} − {y}_{reg} ‖}_{2}^{2} , & if {‖ {R}_{s} − {y}_{reg} ‖}_{2}^{2} + m > {‖ {R}_{t} − {y}_{reg} ‖}_{2}^{2} \\ 0 & or\end{matrix}$$

$${L}_{sL 1} ( {R}_{s} , {y}_{reg} ) = \{ \begin{matrix}0.5 \cdot {( {R}_{s} − {y}_{reg} )}^{2} , if \vert {R}_{s} − {y}_{reg} \vert < 1 \\ \vert {R}_{s} − {y}_{reg} \vert − 0.5 , or\end{matrix}$$

where L_{b}, is a bounded regression loss function of the teacher model, L_{sL1} is a smoothing loss, m is a margin, y_{reg} is a true value of the regression, Rₛ is a regression output of a student network, Rₜ is a regression output of a teacher network, and v is a weight parameter.

Preferably, the transfer learning in S3 is performed by the enterprise, as an initial weight parameter of a specific wind turbine design of the enterprise, and a weight of the student model is accessed to the undeclared parameters of the offshore wind power commercial wind turbine of the enterprise and trained to be a suitable commercial wind turbine design for the enterprise.

Therefore, the invention adopts the above-mentioned method for intelligent design and application of offshore wind turbine structures based on sequential knowledge distillation and transfer learning, and the technical effects are as follows:

(1) The invention obtains more than three random initialization lightweight artificial intelligence by using the pre-trained intelligently designed artificial intelligence regression model of the offshore wind turbine structure as the teacher model, under the supervision of the teacher model, the obtained three or more random initialization lightweight artificial intelligence models obtain similar performance to that of the teacher model by knowledge distillation, finally, the lightweight student model of the intelligently designed artificial intelligence regression model of the offshore wind turbine structure is obtained.

(2) Given the particularity of wind turbine parameter confidentiality in the industry, the lightweight student model parameters can be transmitted to the enterprise. The confidential environmental parameters of commercial wind turbine sea area, wind turbine parameters, and offshore wind turbine structure design parameters can be accessed through transfer learning, the enterprise can quickly complete the model convergence in a small data range, and realize the intelligent design function of the offshore wind turbine structure for the commercial wind turbine.

The following is a further detailed description of the technical scheme of the invention through drawings and an embodiment.

### BRIEF DESCRIPTION OF THE DRAWINGS

FIG. 1 is the flow chart of the method for intelligent design and application of offshore wind turbine structures based on sequential knowledge distillation and transfer learning.

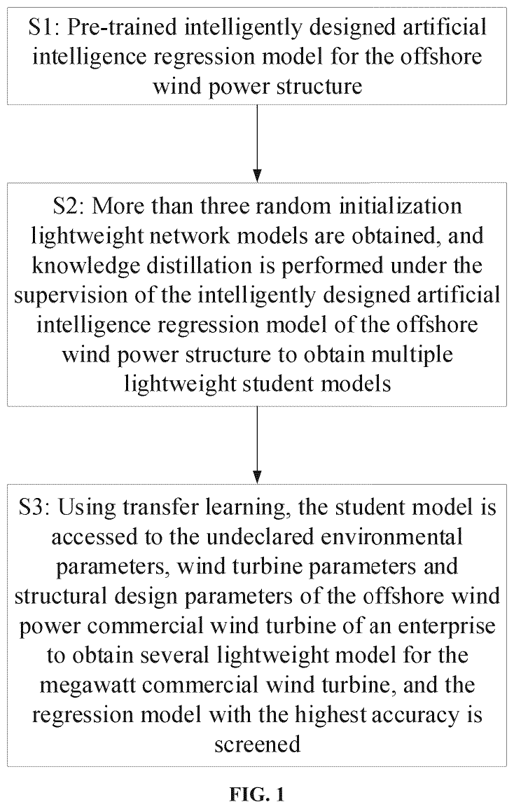

FIG. 2 is an example diagram of the method for intelligent design and application of offshore wind turbine structures based on sequential knowledge distillation and transfer learning.

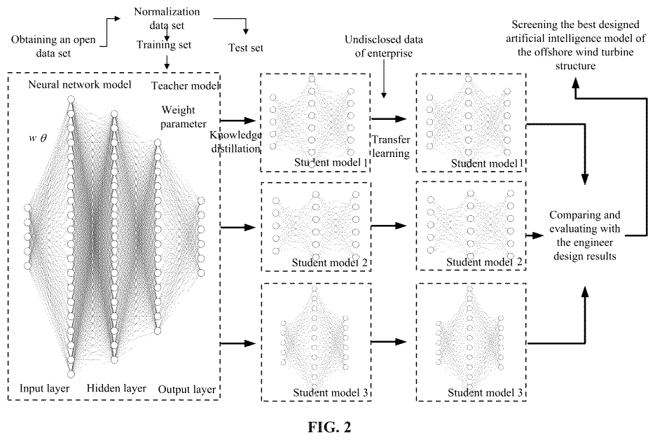

### DETAILED DESCRIPTION OF THE EMBODIMENTS

The following is a further explanation of the technical scheme of the invention through drawings and an embodiment.

Unless otherwise defined, the technical terms or scientific terms used in the invention should be understood by people with general skills in the field to which the invention belongs.

### Embodiment 1

As shown in the figures, the invention provides a method for intelligent design and application of offshore wind turbine structures based on sequential knowledge distillation and transfer learning, including the following steps:

S1, the sea environment parameter, wind turbine parameters, and structural parameters of offshore wind power are collected as the data set, the data set is normalized and divided into a training set and a test set according to the ratio of 8:2, the neural network model is selected as the target model.

S2, the input variables are sea environment parameters (wind speed range, average wind speed, turbulence type, turbulence model, turbulence intensity, wind profile distribution type, surface roughness, horizontal inflow angle, vertical inflow angle, wave simulation method, wave amplitude, wave theory type, swimming speed, water depth, wave period, wave height and wave direction) and wind turbine parameters (wind wheel diameter, rated power, rated speed, design life, mechanical system type, and control system type), the output variables are the height, diameter and thickness of the tower divided into ten sections, and the hyperparameters of the neural network learning rate, momentum gradient, hidden layer number and node number are adjusted, it is trained on the training set until convergence.

S3, the trained neural network regression model of the design of the offshore wind turbine structure is used as the teacher model, the number of the input layer nodes is 23, the number of hidden layer nodes is 128, 96, 32, and the number of output layer nodes is 30; three random initialization lightweight neural network models are obtained, the first lightweight neural network model is the input layer 23, the hidden layer 8 and the output layer 30, the second lightweight neural network model is the input layer 23, the hidden layer 6 and the output layer 30, the third lightweight neural network model is the input layer 23, the hidden layer 12 and the output layer 23.

S4, under the supervision of the teacher model, the knowledge distillation is used to train the lightweight neural network model, the lightweight neural network model is trained to have the same input as that of the teacher model, and the loss function L_{reg} is used to adjust the parameters of the lightweight neural network model until the output error is highly similar to the student model within 5%.

S5, L_{reg} is used to evaluate the difference between the predicted value of the student model and the predicted value of the teacher model. The loss function L_{reg} can be expressed as L_{reg}=L_{sL1}(Rₛ, yᵣₑₛ)+vL_{b}(Rₛ, Rₜ, y_{reg})

$${L}_{b} ( {R}_{s} , {R}_{t} , {y}_{reg} ) = \{ \begin{matrix}{‖ {R}_{s} − {y}_{reg} ‖}_{2}^{2} , & if {‖ {R}_{s} − {y}_{reg} ‖}_{2}^{2} + m > {‖ {R}_{t} − {y}_{reg} ‖}_{2}^{2} \\ 0 & or\end{matrix}$$

$${L}_{sL 1} ( {R}_{s} , {y}_{reg} ) = \{ \begin{matrix}0.5 \cdot {( {R}_{s} − {y}_{reg} )}^{2} , if \vert {R}_{s} − {y}_{reg} \vert < 1 \\ \vert {R}_{s} − {y}_{reg} \vert − 0.5 , or\end{matrix}$$

where L_{b} is a bounded regression loss function of the teacher model, L_{sL1} is a smoothing loss, m is a margin, y_{reg} is a true value of the regression, Rₛ is a regression output of a student network, Rₜ is a regression output of a teacher network, and v is a weight parameter.

S6, the weight parameters of multiple student models trained are transmitted to the enterprise, and the transfer learning is used to access the confidential commercial wind turbine sea environment parameters, wind turbine parameters, and offshore wind turbine structure design parameters, which can quickly complete the model convergence in a small data set, so that it can be trained as an intelligent designed neural network model for the offshore wind turbine structure of the commercial wind turbine.

S7, it is designed in actual through practice, the difference is compared by the design of the engineers, the best performance model is screened from several intelligent designed neural network models of the offshore wind turbine structure as the intelligent designed neural network model of the offshore wind turbine structure for commercial wind turbines.

Therefore, the invention adopts the above-mentioned method for intelligent design and application of offshore wind turbine structures based on sequential knowledge distillation and transfer learning, based on the intelligently designed artificial intelligence regression model of the offshore wind turbine structure completed by pre-training on the public training set, the knowledge distillation of the regression model can reduce the excessive parameterization behavior of the existing artificial intelligence regression model, and obtain multiple lightweight student models with strong generalization and easy transmission, and then the weight parameters of the student model are transmitted to the enterprise, and the confidential commercial wind turbine sea area environmental parameters, wind turbine parameters and offshore wind turbine structure design parameters are accessed, it can make the model quickly re-complete the model convergence in the small data range, and realize the intelligent design function of the offshore wind turbine structure for the commercial wind turbines.

Finally, it should be explained that the above embodiments are only used to explain the technical scheme of the invention rather than restrict it, although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A method for intelligent design and application of offshore wind turbine structures based on sequential knowledge distillation and transfer learning, comprising the following steps:
S1, obtaining an open data set of offshore wind power, and dividing the open data set into a training set and a test set, pre-training an intelligently designed artificial intelligence regression model of the offshore wind turbine structure, wherein input parameters are wind turbine parameters and sea environment parameters, and output parameters are offshore wind turbine structure design parameters;
S2, obtaining more than three random initialization lightweight network models, under a supervision of the intelligently designed artificial intelligence regression model of the offshore wind turbine structure as a teacher model, performing a knowledge distillation of the lightweight network models to obtain a highly similar lightweight student model with a same input as the teacher model and an output difference within 5%;
S3, performing a transfer learning for the highly similar lightweight student model, and accessing undeclared environmental parameters, wind turbine parameters, and structural design parameters of an offshore wind power commercial wind turbine of an enterprise to obtain a lightweight model for a megawatt commercial wind turbine, and screening a regression model with a highest accuracy.

2. The method for the intelligent design and application of the offshore wind turbine structures based on the sequential knowledge distillation and transfer learning according to claim 1, wherein the wind turbine parameters in S1 comprise wind wheel diameter, rated power, rated speed, design life, mechanical system type, and control system type.

3. The method for the intelligent design and application of the offshore wind turbine structures based on the sequential knowledge distillation and transfer learning according to claim 1, wherein the sea environment parameters in S1 comprise wind speed range, average wind speed, turbulence type, turbulence model, turbulence intensity, wind profile distribution type, surface roughness, horizontal inflow angle, vertical inflow angle, wave simulation method, wave amplitude, wave theory type, swimming speed, water depth, wave period, wave height and wave direction.

4. The method for the intelligent design and application of the offshore wind turbine structures based on the sequential knowledge distillation and transfer learning according to claim 1, wherein the offshore wind turbine structure design parameters in S1 comprise tower diameter, height, and thickness.

5. The method for the intelligent design and application of the offshore wind turbine structures based on the sequential knowledge distillation and transfer learning according to claim 1, wherein an output height in S2 is determined by a loss function, a damage function between the teacher model and the highly similar lightweight student model of the regression model for knowledge distillation is L_{reg}, a calculation method is:
$${L}_{r e g} = {L}_{sL 1} ( {R}_{s} , {y}_{r e g} ) + v {L}_{b} ( {R}_{s} , {R}_{t} , {y}_{r e g} )$$
$${L}_{b} ( {R}_{s} , {R}_{t} , {y}_{reg} ) = \{ \begin{matrix}{‖ {R}_{s} − {y}_{reg} ‖}_{2}^{2} , & if {‖ {R}_{s} − {y}_{reg} ‖}_{2}^{2} + m > {‖ {R}_{t} − {y}_{reg} ‖}_{2}^{2} \\ 0 & or\end{matrix}$$
$${L}_{sL 1} ( {R}_{s} , {y}_{reg} ) = \{ \begin{matrix}0.5 \cdot {( {R}_{s} − {y}_{reg} )}^{2} , if \vert {R}_{s} − {y}_{reg} \vert < 1 \\ \vert {R}_{s} − {y}_{reg} \vert − 0.5 , or\end{matrix}$$
where L_{b} is a bounded regression loss function of the teacher model, L_{sL1} is a smoothing loss, m is a margin, y_{reg} is a true value of a regression, Rₛ is a regression output of a student network, Rₜ is a regression output of a teacher network, and v is a weight parameter.

6. The method for the intelligent design and application of the offshore wind turbine structures based on the sequential knowledge distillation and transfer learning according to claim 1, wherein the transfer learning in S3 is performed by the enterprise, as an initial weight parameter of a specific wind turbine design of the enterprise, a weight of the highly similar lightweight student model is accessed to undeclared parameters of the offshore wind power commercial wind turbine of the enterprise and trained to be a suitable commercial wind turbine design for the enterprise.
